(19) United States
(12) Patent Application Publication
(10) Pub. No.: US 2008/0289147 A1
(43) Pub. Date: Nov. 27, 2008

(54) Dual-hinge mechanism and related methods

(76) Inventors: Rory Patrick Falato, West Chester, OH (US); Robert Joseph Clark, Cincinnati, OH (US); Marvin L. Woolam, Redmond, OR (US); Carl D. Johnson, Culver, OR (US)

Correspondence Address: FROST BROWN TODD, LLC, 2200 PNC CENTER, 201 E. FIFTH STREET, CINCINNATI, OH, 45202, US

(21) Appl. No.: 11/411,599

(22) Filed: Apr. 25, 2006

Related U.S. Application Data
(60) Provisional application No. 60/675,560, filed on Apr. 29, 2005.

(51) Int. Cl. E05D 7/00; E05D 5/00

(52) U.S. Cl. 16/382; 49/385

(57) ABSTRACT

The present invention provides a mechanism for mounting a door comprising a dual-hinge or “double-knuckle” spine/hinge system which allows a traffic door to open a full 180 degrees in both directions from a closed position. The mechanism allows the door to be flush with a wall that is adjacent to the door resulting in minimal obstruction of hallways and/or other traffic areas into which the door opens, thereby significantly increasing the efficient use of limited space. The present invention also provides a mechanism for cushioning a door against sudden impacts and reducing the stresses from loads that are commonly placed on the door and jamb due to frequent opening and closing.

### CROSS-REFERENCE TO RELATED APPLICATIONS

The present application claims the benefit of U.S. Provisional Application Ser. No. 60/675,560, filed on Apr. 27, 2005, which is incorporated in its entirety herein by reference.

### FIELD OF THE INVENTION

The present disclosure relates generally to mechanical couplings and, more particularly, to hinge mechanisms and systems useful primarily in swinging doors.

### BACKGROUND OF THE INVENTION

Swinging doors (as opposed to sliding doors) are typically mounted on hinges that permit the doors to pivotally swing as the door opens and closes. Double-acting doors, in which the door can swing open in two directions, both inwardly and outwardly, have a limited opening angle. In other words, double-acting doors typically do not open to a full 180 degrees in both directions. Rather, the angle at which the door can open is generally significantly limited by the door making physical contact with the jamb. The limited angle results in inefficient use of space by limiting or otherwise impeding traffic flow in many applications. For instance, opening a conventional double-acting door in areas with significant traffic will present an obstruction to cross-traffic and otherwise impede the efficient flow of traffic in the general area of the door.

In addition, typically the door panels, hinges and jambs of conventional doors frequently have potentially damaging loads placed on them. For example, when a conventional door is opened and makes physical contact with the jamb, thus limiting its travel, force typically continues to be applied to the door, resulting in a potentially damaging load being placed on the door panel, the hinges and the jamb.

Further, the door, hinges and jambs of conventional double-action and other doors undergo considerable stress when a door at rest is subjected to a sudden hard impact, thus placing a potentially damaging load directly on the door, hinges and the jamb. Accordingly, the door, hinges and jamb of a conventional door, which lacks a mechanism to effectively absorb the force of such impacts, are subject to significantly greater stresses than a comparable door possessing such an impact absorbing mechanism. Naturally, the cumulative effect of the increased loads caused by, e.g., sudden impacts and loads resulting from attempts to push the door open beyond its limited opening angle, can cause failure, malfunction or otherwise significantly shorten the useful life of the door, hinges and jamb.

In view of these deficiencies, a need exists in the art for a hinge-mechanism which allows a door to swing open to a full 180 degrees, and a particular need exists for a hinge-mechanism which allows a double-acting door to open a full 180 degrees in both directions. A further need exists in the art for a hinge mechanism capable of eliminating, cushioning or absorbing the potentially damaging loads that are regularly placed on doors, door hinges and door jambs during the course of their everyday use.

The present invention provides improvements over conventional double-acting traffic doors and door mounts in that its design allows for a door, including a double-acting door, to open a full 180 degrees in both directions. The design of the present invention also functions to cushion or absorb potentially damaging loads which are regularly placed on doors, including double-acting doors. Other advantages will be disclosed and/or apparent from the following disclosure.

### SUMMARY OF THE INVENTION

The present invention provides a dual-hinge or “double-knuckle” spine/hinge system which allows a traffic door to open a full 180 degrees in both directions from its closed position. This permits the door to be flush with a wall that is adjacent to the door, thereby minimally obstructing hallways and/or other traffic areas into which the door opens. Accordingly, the present invention significantly increases the efficient use of limited space.

The unique hinge mechanism of the present invention also effectively provides a cushion against sudden impacts on the door. For example, when the door experiences a hard impact while it is closed, the dual-hinge mechanism gives way momentarily, effectively absorbing or cushioning the forces of the impact. This cushioning can reduce or eliminate any damage that may normally occur in the absence of such a dual-hinge mechanism.

Moreover, it is well known that the hinge and jamb sections of a conventional door are common failure points. The dual-hinge mechanism of the present invention reduces the stresses from loads that are commonly placed on the door and jamb due to frequent opening and closing, including attempts to open the door further after it has made contact with the jamb. The reduced stress results in less frequent failures at the hinge and/or jamb, since these loads are now distributed over two hinge mechanisms.

Specifically, the present invention provides a mechanism for mounting a door comprising a door and a means for pivoting the door up to about 180 degrees in either direction from the closed position. In one embodiment of the present invention, the pivoting means includes a primary spine element having a first end, a second end, a top and a bottom, the primary spine being pivotally coupled at one end to a jamb; a secondary spine element having a first end, a second end, a top and a bottom, the secondary spine being pivotally coupled at the first end to the primary spine, and coupled at the second end to a door.

In operation of a particular embodiment of the present invention, the primary spine element pivots about the bracket until the primary spine element makes physical contact with the door jamb. The physical contact between the primary spine element and the jamb prohibits further pivoting of the primary spine element. Once the primary spine element is prohibited from further pivoting about the bracket, additional force on the door results in the door pivoting around the top and bottom hinges, thus allowing the door to pivot to a full 180 degrees from its closed position.

In a preferred embodiment of the present invention, the mechanism of the present invention is used to mount a double-acting or swinging door.

The design and operation of the present invention, as well as its advantages, will be more fully appreciated upon reference to the following detailed description having reference to the accompanied drawings.

### BRIEF DESCRIPTION OF THE FIGURES

Many aspects of the disclosure can be better understood with reference to the following drawings. All of the components in the drawings are not necessarily to scale, emphasis instead being placed upon clearly illustrating the principles of the present disclosure. Moreover, in the drawings, like reference numerals designate corresponding parts throughout the several views.

FIGS. 1 (A)-(E) depicts perspective views of a preferred embodiment of the dual-hinge mechanism of the present invention: (A) side isometric view; (B) view of the back spine with CAM and top pivot; (C) view of back spine; (D) top view; and (E) bottom view.

FIG. 2 is a cross-sectional view of the dual-hinge mechanism including the Primary Spine, Secondary Spine, Primary Hinge and Secondary Hinge.

FIG. 3 is a top view of the dual-hinge mechanism in: (A) a fully closed position; (B) opened 180 degrees to rear; and (C) opened 180 degrees to the front.

FIG. 4 depicts top, perspective and cross-sectional views of a Double Knuckle Secondary Spine.

FIG. 5 is a perspective view of a Double Knuckle Hinge.

FIGS. 6 (A)-(C) depicts perspective views of the Top Hinge Assembly and the Lower Hinge Assembly including the Upper Hinge Bracket (primary), the Top Spine Holder (secondary), the Secondary Spine, the Primary Spine, the Lower Jamb Guard, and the Bottom Spine Holder. Operation of the dual (double knuckle) hinge is also depicted: (A) in the fully closed position; (B) in an open position such that the Primary Spine is fully open and 90 degrees-100 degrees and the Secondary Spine engages; and (C) in a position such that the Secondary Spine is fully open at 180 degrees.

FIG. 7 depicts top, perspective and cross-sectional views of a Double Knuckle Primary Spine.

FIG. 8 depicts top, perspective and cross-sectional views of the Upper Spine Holder.

FIG. 9 depicts top, perspective and cross-sectional views of the Lower Spine Holder.

FIG. 10 depicts top, perspective and cross-sectional views of a Double Knuckle Top Bracket.

FIG. 11 depicts top, perspective and cross-sectional views of a Double Knuckle Jamb Guard.

FIG. 12 depicts top, perspective and cross-sectional views of the CKR Lower HDPE Cam.

FIG. 13 depicts top, perspective and cross-sectional views of the CKR SST Cam.

FIG. 14 depicts top, perspective and cross-sectional views of the CKR Top Plug.

FIG. 15 depicts top, perspective and cross-sectional views of the CKR Top Sleeve.

### DETAILED DESCRIPTION OF THE EMBODIMENTS

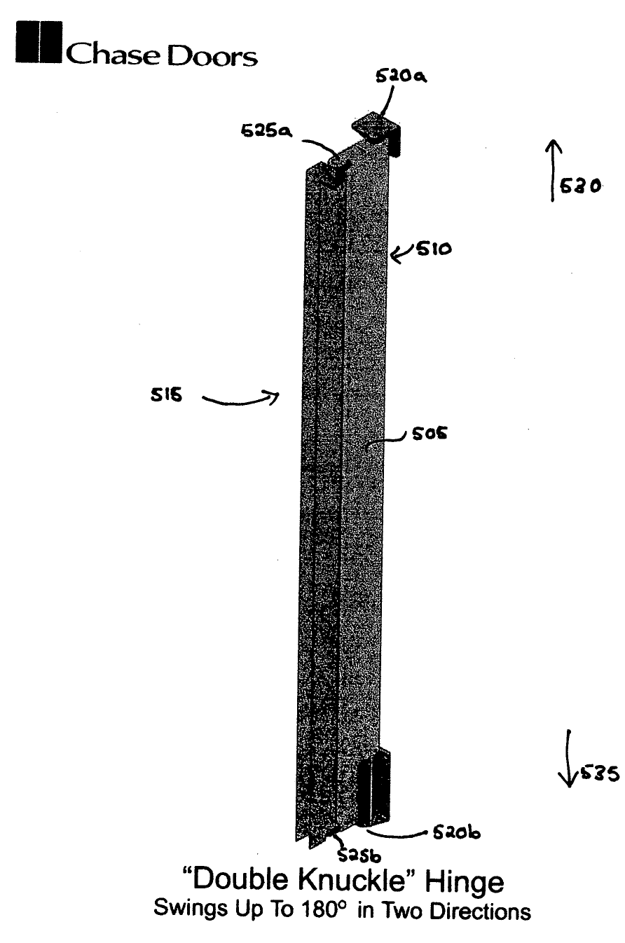

Referring to FIG. 5 of the drawings, one embodiment, among others, of a dual-hinge mechanism is shown. Specifically, a perspective view of a dual-hinge mechanism is shown with reference to FIG. 5. As shown, the embodiment of FIG. 5 includes a spine 505 having both a top 530 and a bottom 535. The spine 505 further includes a jamb end 510 and a door end 515. In that regard, when finally assembled, a door (not shown in FIG. 5) is mounted onto the spine 505 at the door end 515, while the jamb end 510 of the spine 505 is itself mounted into the jamb of the doorway (not shown in FIG. 5).

At the jamb end 510, the top 530 includes an upper bracket 520a while the bottom 535 includes a lower bracket 520b. The upper bracket 520a and the lower bracket 520b permit mounting of the spine 505 to a door jamb (not shown in FIG. 5). Once mounted onto the jamb, the spine 505 can freely pivot about the brackets 520a, 520b, both inwardly and outwardly. However, as one can appreciate from the drawings, the pivot angle for the spine 505 will be limited, insofar as the spine 505 is permitted to swing open until it makes physical contact with the jamb.

Similarly, at the door end 515, the top 530 includes an upper hinge 525a and the bottom 535 includes a lower hinge 525b. The upper hinge 525a and the lower hinge 525b permit mounting of a door (not shown in FIG. 5) that will pivot around these two hinges 525a, 525b. In isolation, the pivot angle for the door, with reference to the spine 505, is physically limited because the door is permitted to swing open until the point at which it makes contact with the spine 505.

While the pivot angle of the spine 505 with reference to the jamb is limited, and the pivot angle of the door with reference to the spine 505 is also limited, the combined pivot angles permit the door to swing open at a full 180 degrees in either direction with reference to the jamb. In other words, the aggregate of the pivot angles (i.e., the combination of spine 505 and the jamb, as well as the door and the spine 505) provides a mechanism by which the door can swing open to a 180-degree angle, either inwardly and/or outwardly, from its fully closed position.

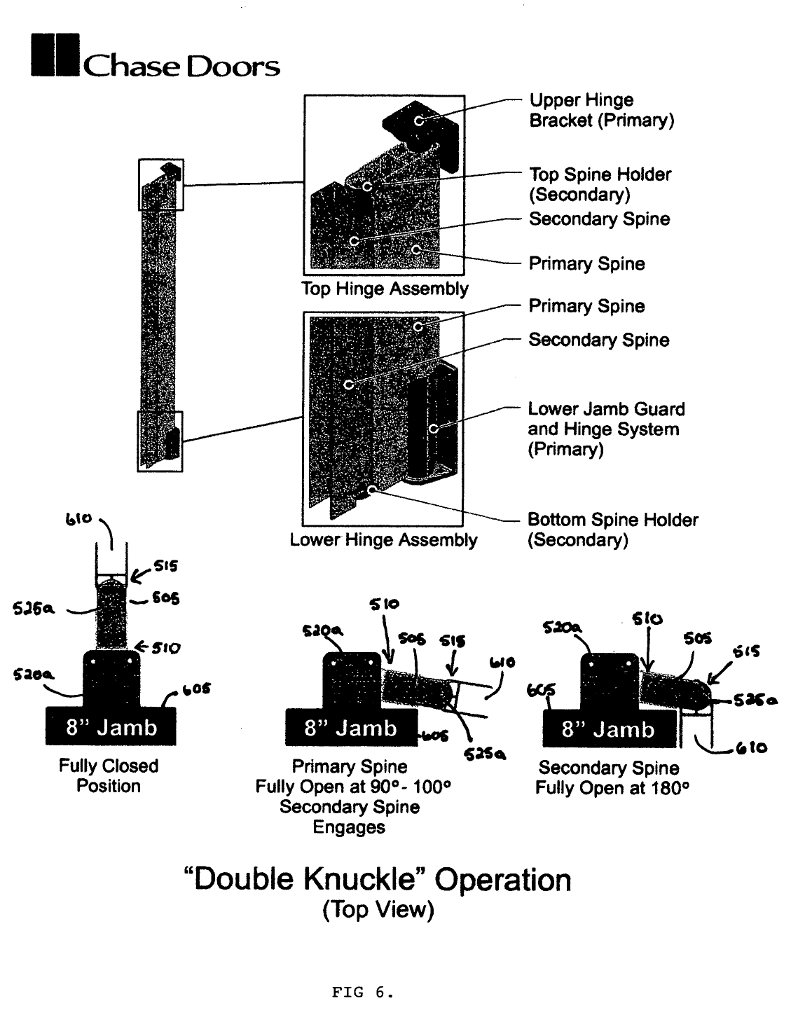

To illustrate the operation of such a hinge mechanism, a top view of the hinge mechanism is provided with reference to FIG. 6, which is labeled as “double-knuckle” operation. Specifically, FIG. 6A shows a dual-hinge mechanism when a door 610 is in its fully closed position. As shown in FIG. 6A, the bracket 520a is mounted onto a jamb 605. The spine 505, which includes a hinge 525a on its door end 515, is mounted onto the bracket 520a. In turn, a door 610 is mounted onto the hinge 525a of the spine 505.

For clarity of illustration, the jamb 605 is specifically drawn as an 8 inch jamb. However, it should be appreciated that the dimensions of the jamb 605 can be altered without detrimental effect on the operation of the dual-hinge mechanism.

FIG. 6B shows pivoting of the spine 505 as the door 610 opens. As shown in FIG. 6B, the spine 505 pivots about the bracket 520a until the spine 505 makes physical contact with the jamb 605. The physical contact between the spine 505 and the jamb 605 prohibits further pivoting of the spine 505. For convenience, the pivoting of the spine 505 with reference to the jamb 605 is referred to as a primary pivoting action.

FIG. 6C shows pivoting of the door 610 as the door is opens further. As shown in FIG. 6C, once the spine 505 is prohibited from further pivoting about the bracket 520a, additional force on the door 610 results in the door 610 pivoting around the hinge 525. For convenience, the pivoting of the door 610 with reference to the spine 505 is referred to as a secondary pivoting action. As long as the dimensions of the spine 505 are sufficiently large to clear the jamb 605, the secondary pivoting action permits the door to open until the door is flush with the wall (not shown) that is adjacent to the jamb 605.

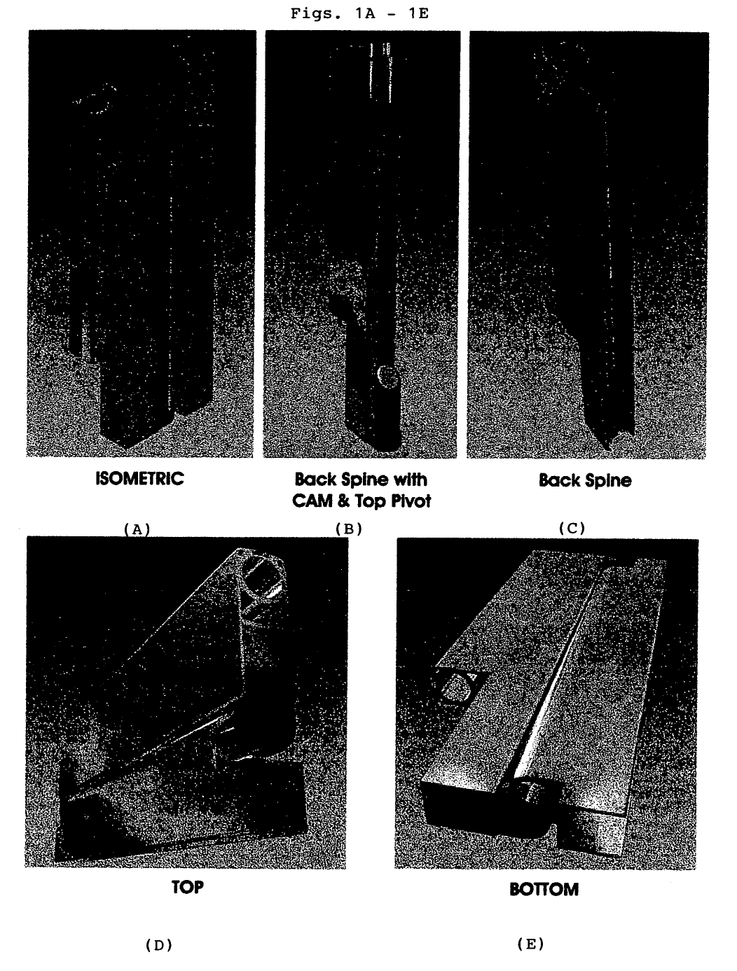

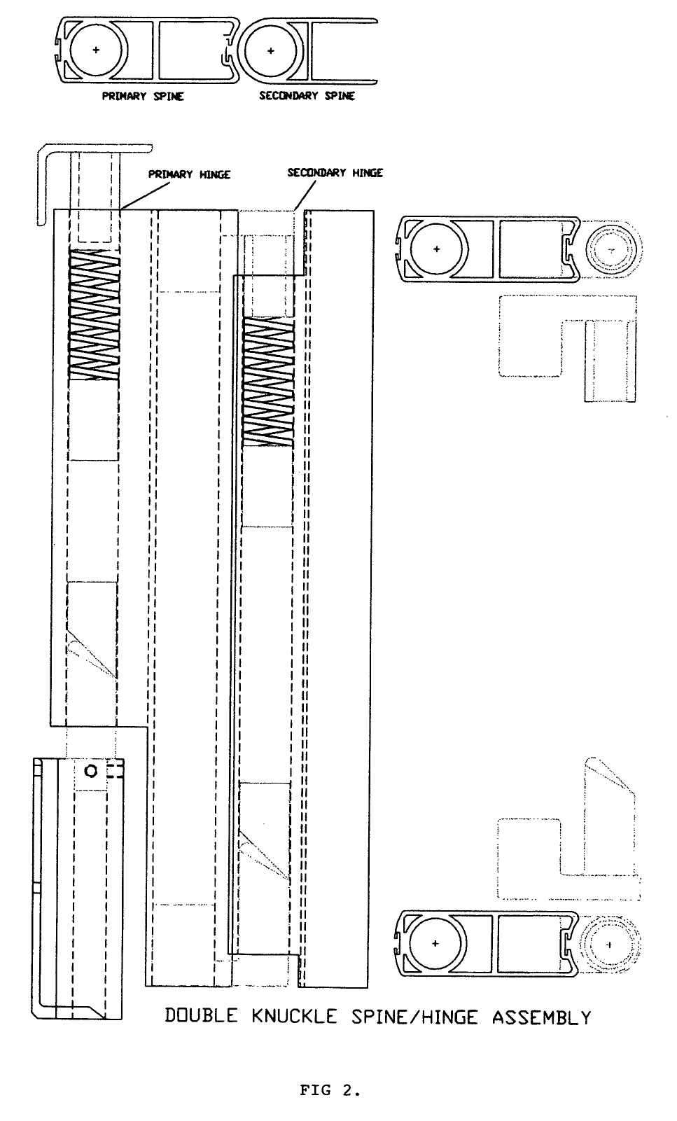

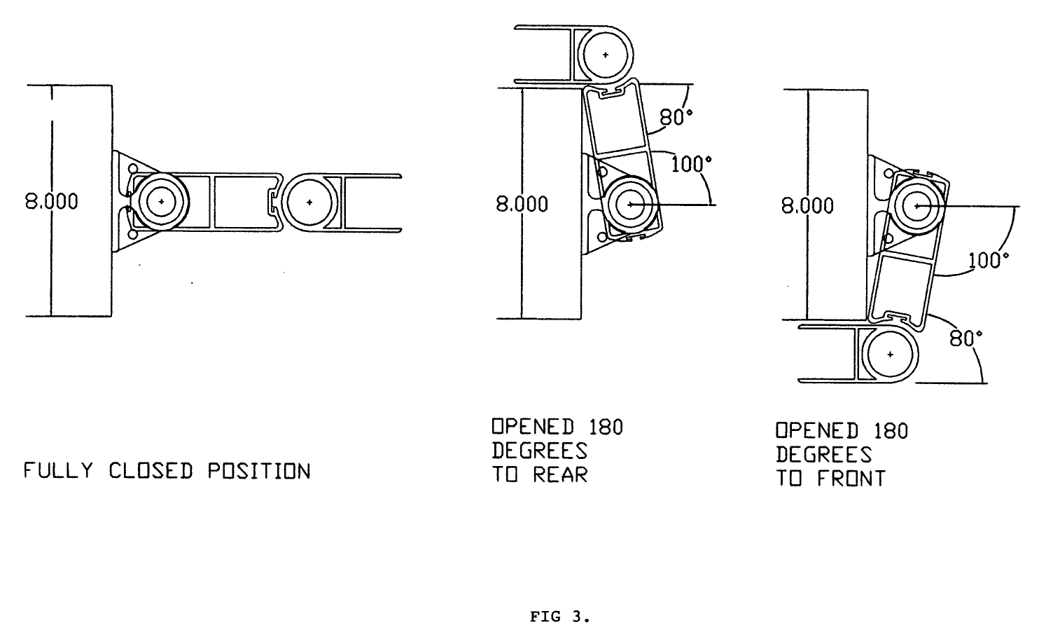

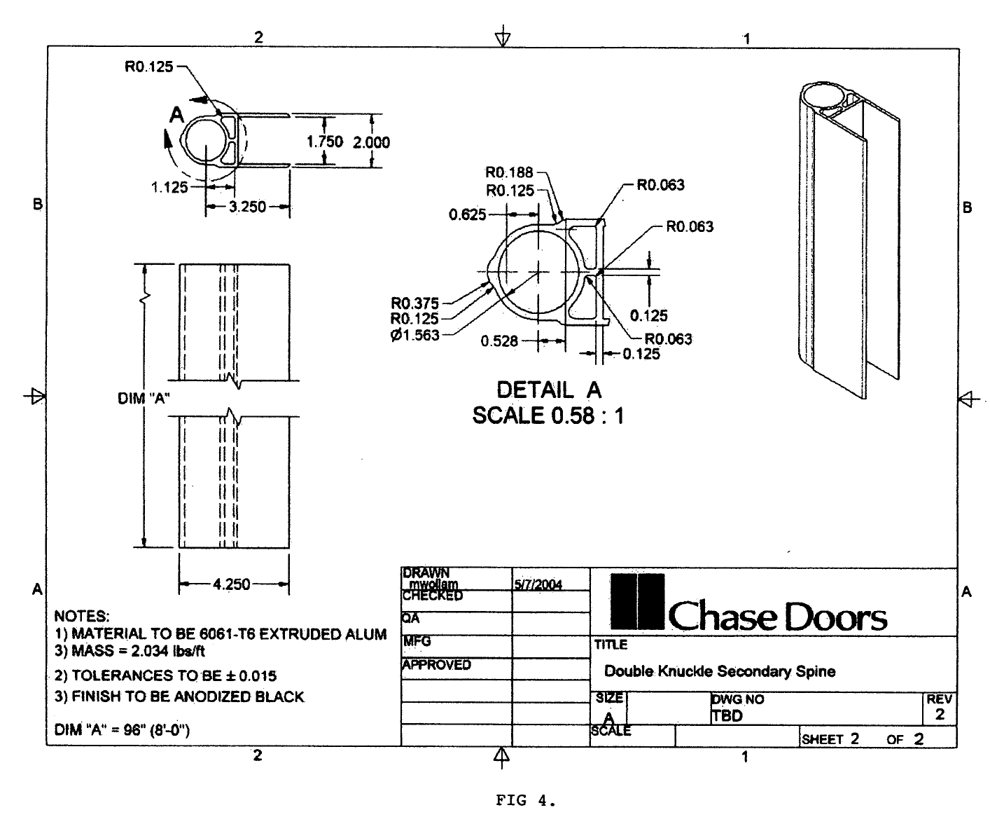

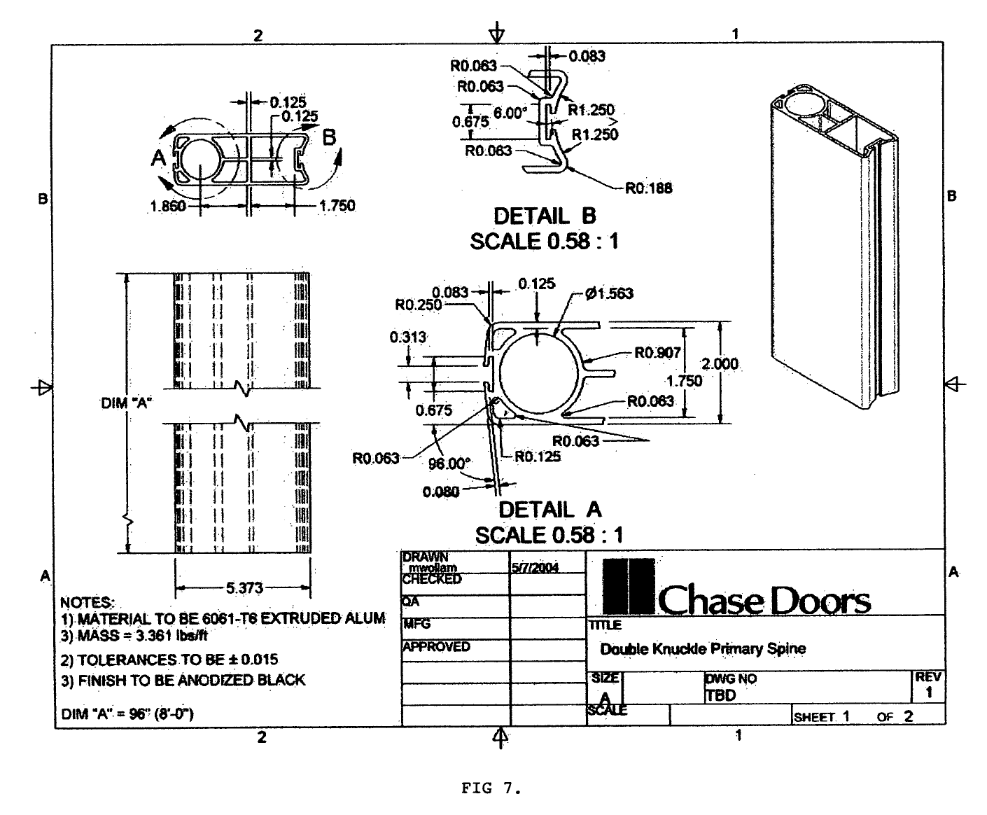

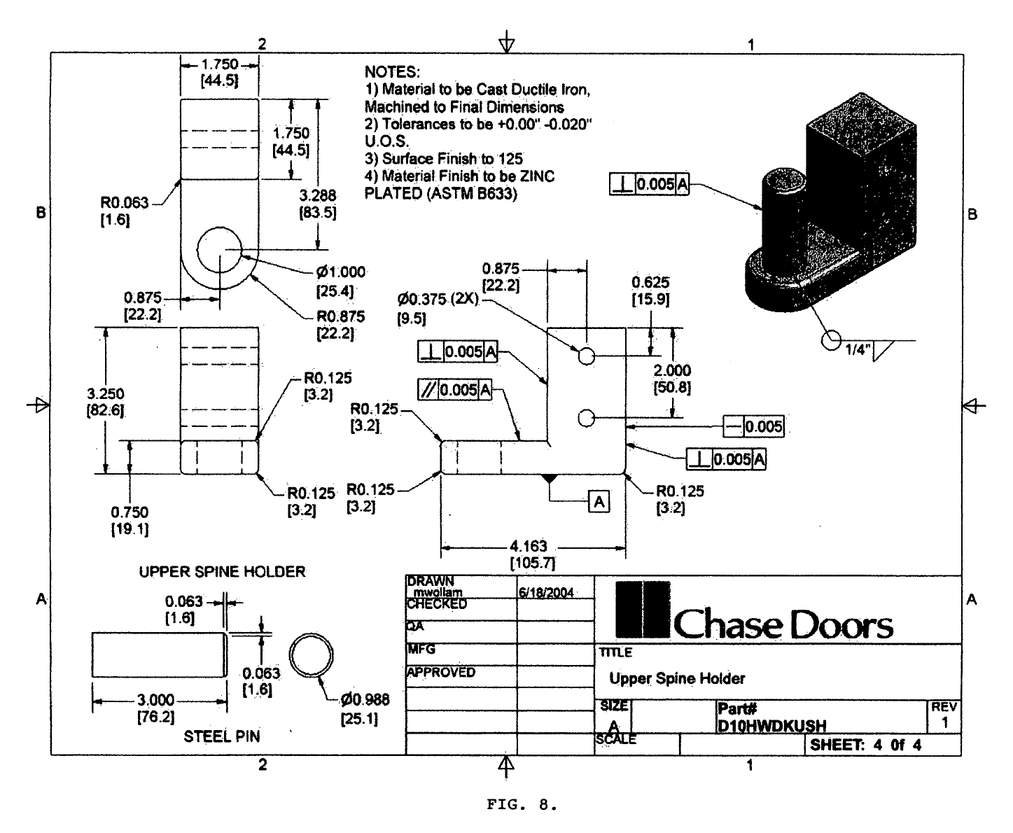

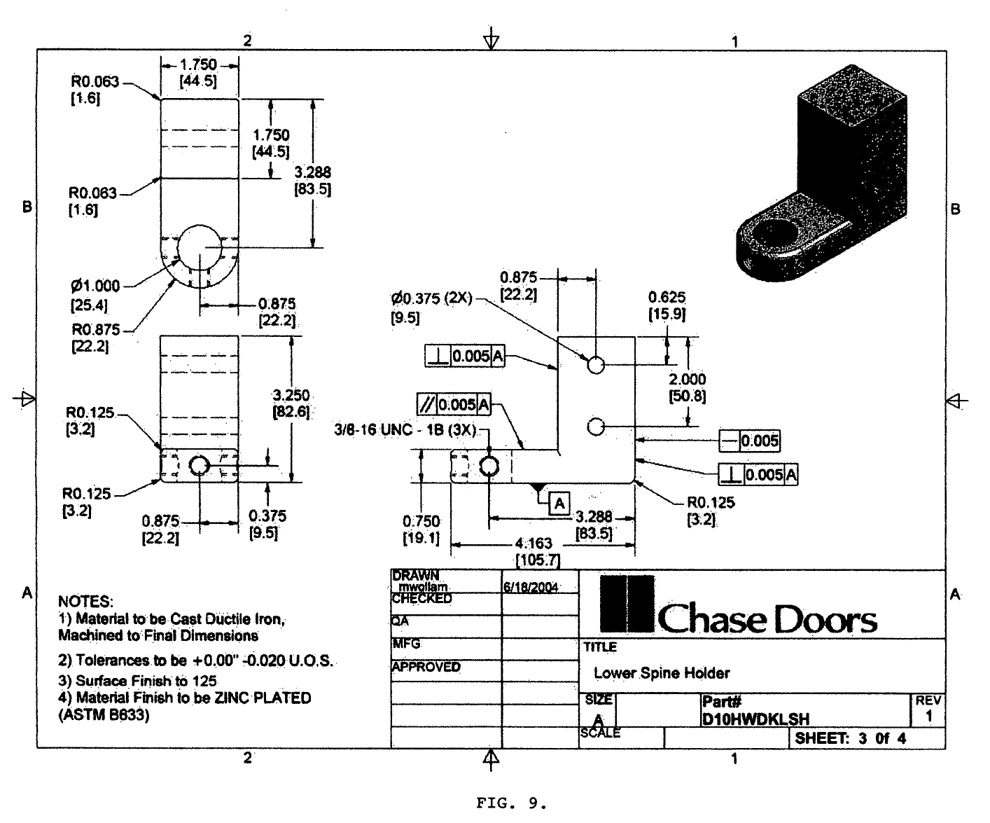

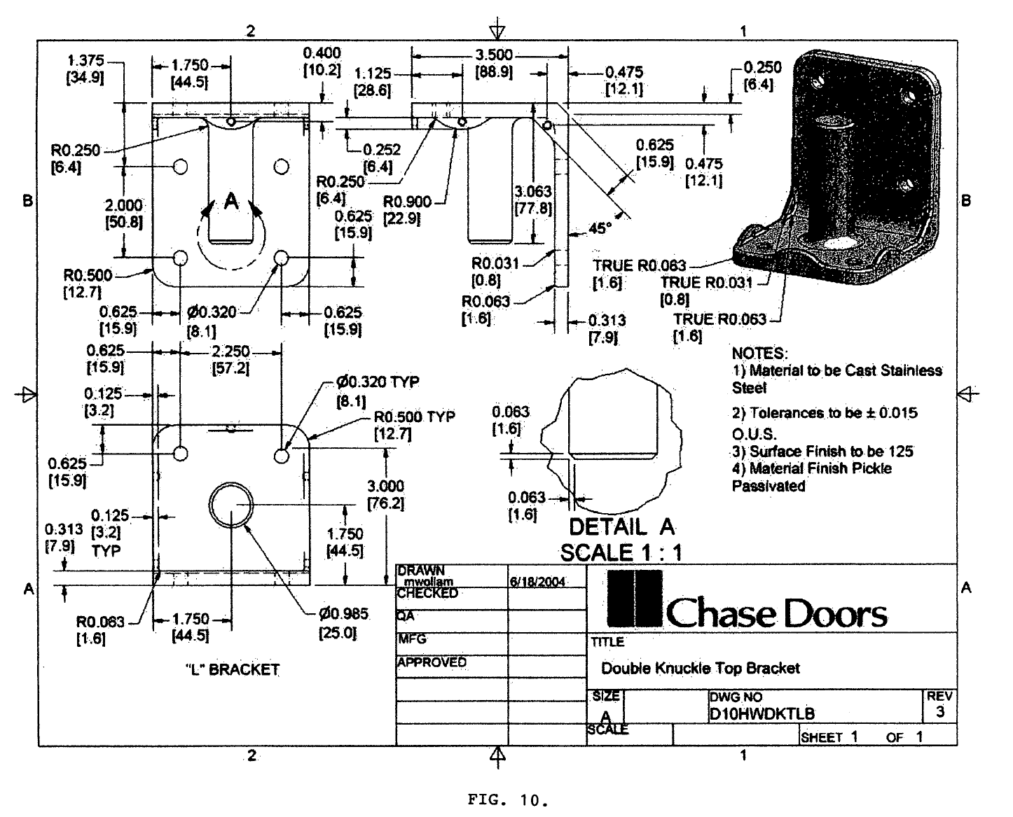

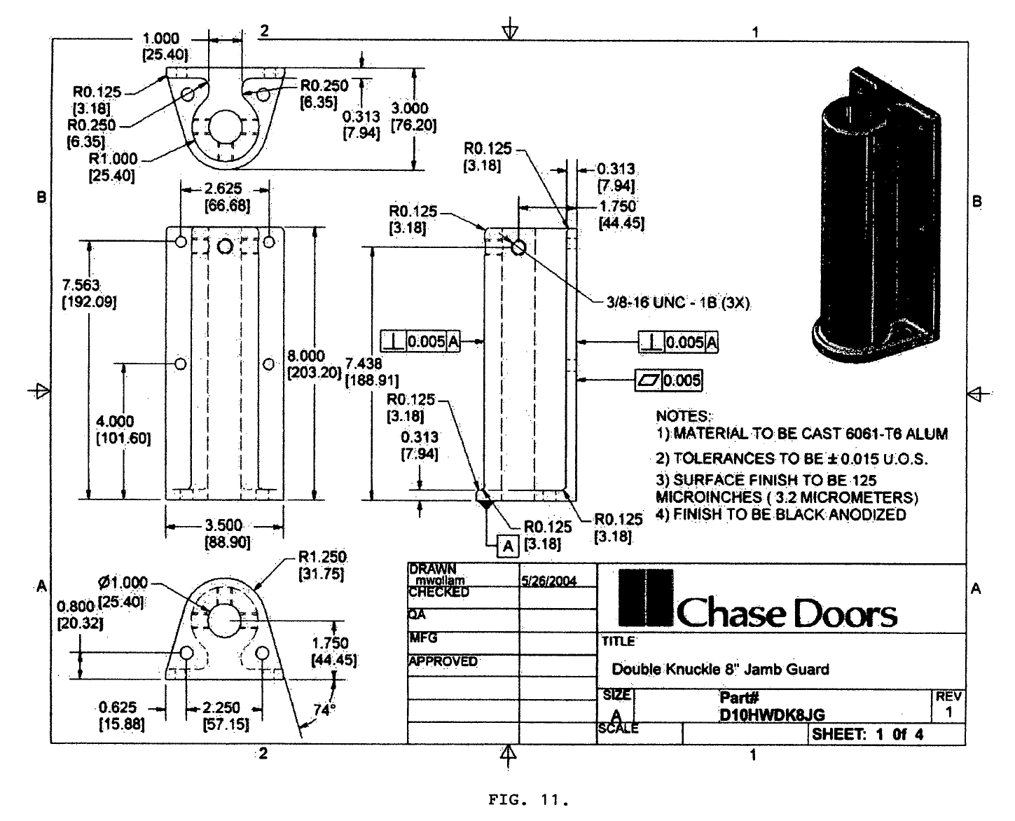

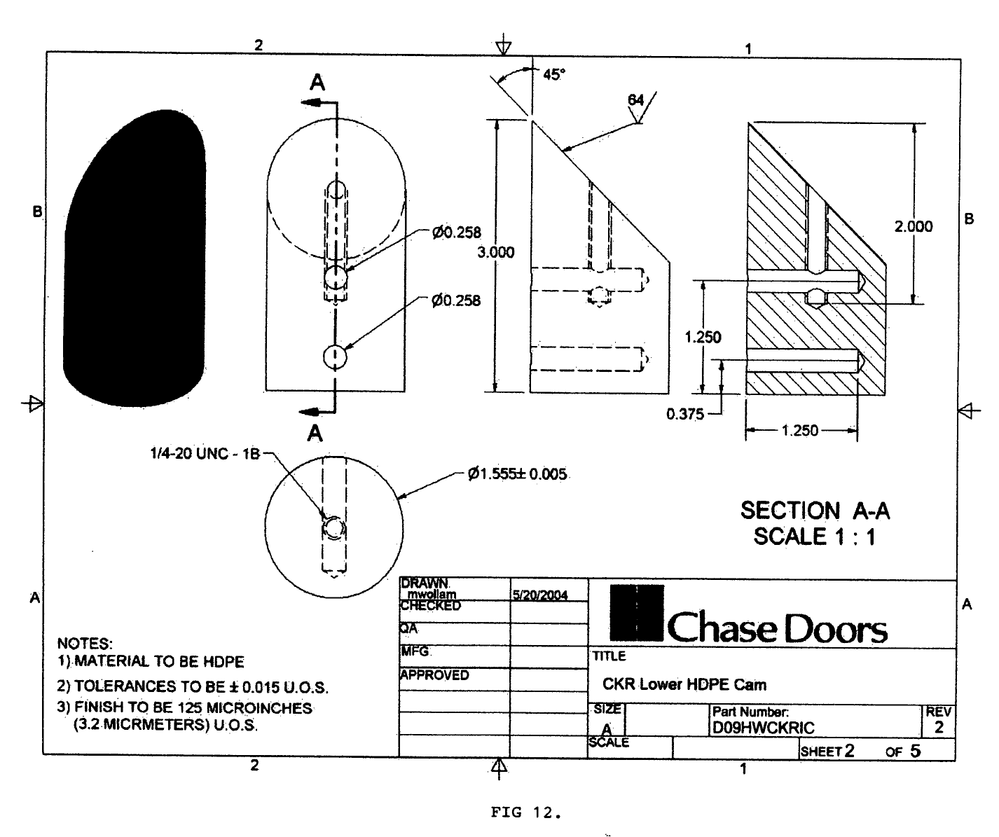

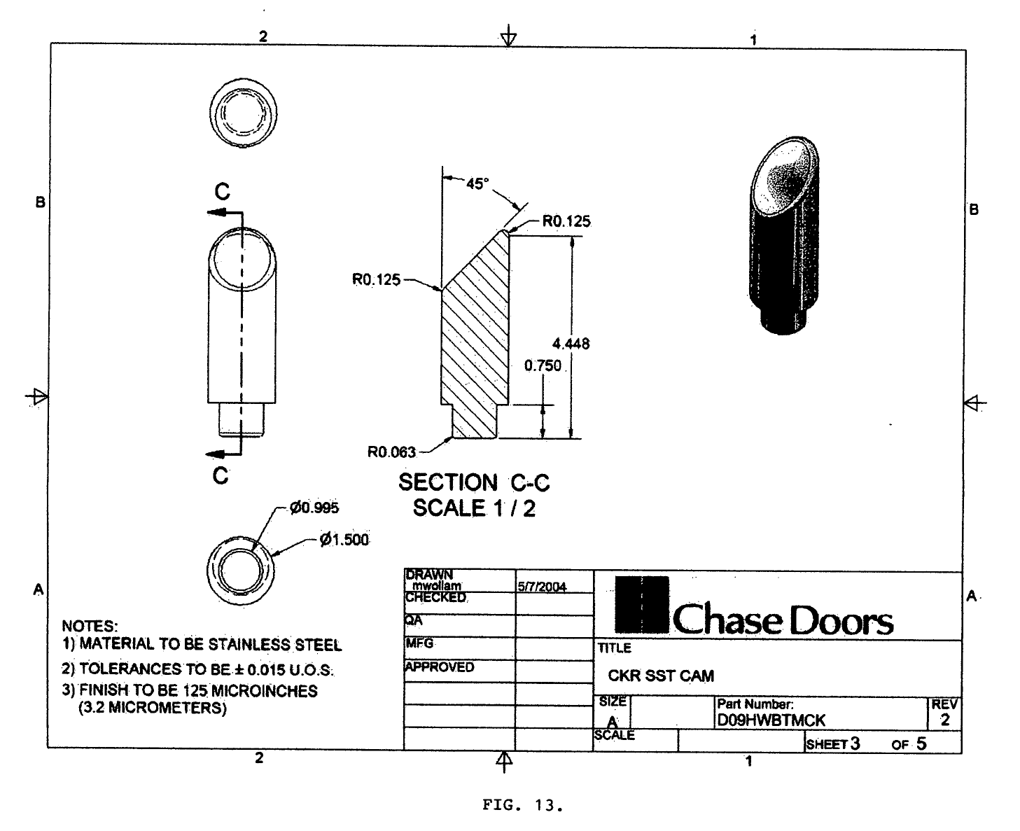

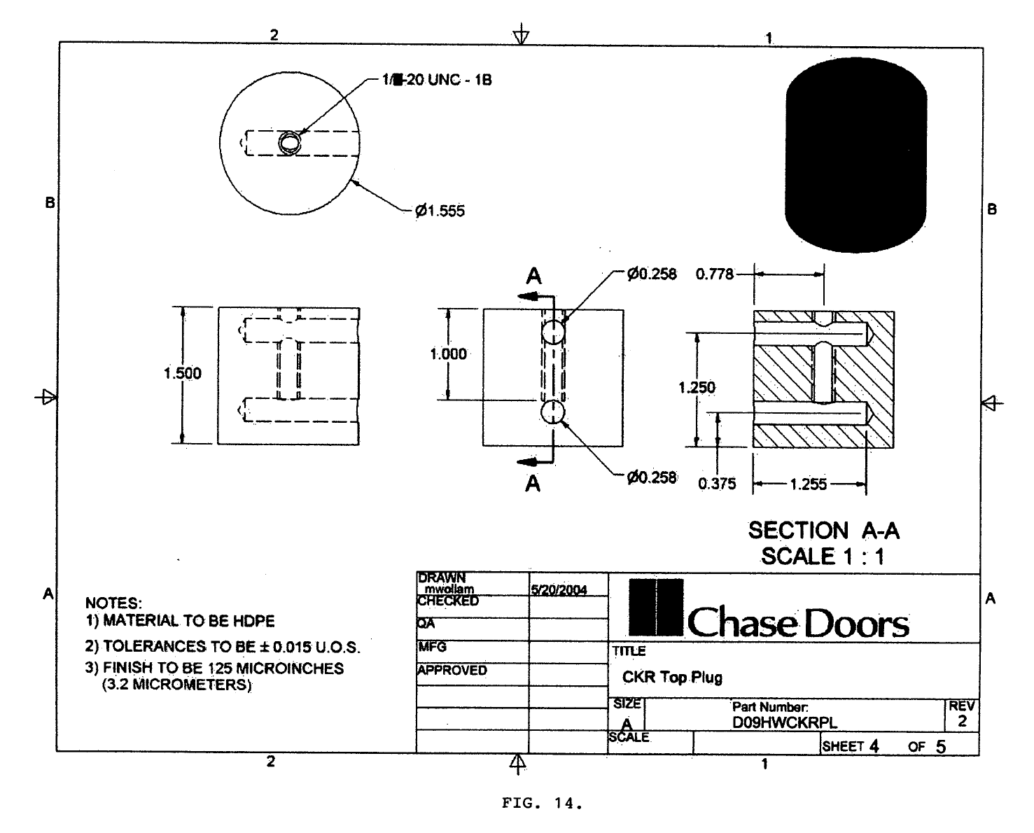

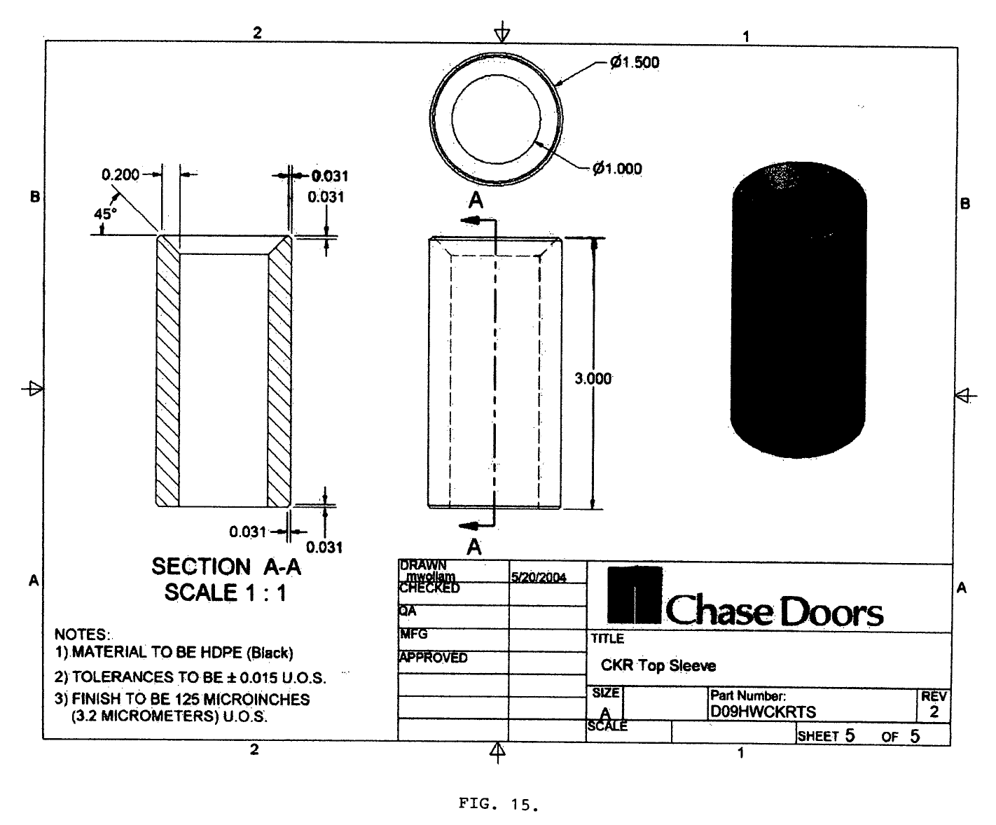

The remaining drawings (FIGS. 1 through 4 and FIGS. 7 through 15) show various components of the dual-hinge mechanism described in FIGS. 5 and 6.

The dual-hinge mechanism, as described above, permits a door to open to a full 180 degrees in either direction from its closed position. This permits the door to be flush with a wall that is adjacent to the door, thereby minimally obstructing hallways and/or other traffic areas into which the door opens.

Additionally, the hinge mechanism, as described above, effectively provides a cushion against sudden impacts on the door. For example, when the door experiences a hard impact while it is at rest in the closed position, the dual-hinge mechanism gives way momentarily to absorb or cushion the impact. This cushioning can reduce any damage that may normally occur in the absence of such a dual-hinge mechanism.

Lastly, as is known, the hinge and or jamb part of a conventional door is a common failure point. The dual-hinge mechanism, as described above, reduces the stresses that are commonly placed on the door and jamb due to frequent opening and closing. The reduced stress results in less frequent failures at the hinge and or jamb, since this load is now distributed over two hinge mechanisms.

Although exemplary embodiments have been shown and described in detail for purposes of clarity, it will be clear to those of ordinary skill in the art from a reading of the disclosure that various changes in form or detail, modifications, or other alterations to the invention as described may be made without departing from the true scope of the invention in the appended claims. For example, while specific dimensions for a hinge mechanism and a door are shown, it should be appreciated that changes to the dimensions of the hinge mechanism and/or the door will not detract from the inventive concept. Accordingly, all such changes, modifications, and alterations should be seen as within the scope of the disclosure.

We claim:

1. A mechanism for mounting a door, comprising: a door; and means for pivoting the door up to about 180 degrees in either direction.

2. The mechanism of claim 1, where the door is a double-acting door

3. A mechanism for mounting a door, comprising: a spine having a first end and a second end; a first hinge mechanism located at the first end of the spine; and a second hinge mechanism located at the second end of the spine.

4. The mechanism of claim 3, where the door is a double-acting door.

5. A mechanism for mounting a door, comprising: a spine having a first end, a second end, a top and a bottom; a top hinge located at the top of the first end, the top hinge being configured to couple to a top of a door; a bottom hinge located at the bottom of the first end, the bottom hinge being configured to couple to a bottom of the door; a top bracket located at the top of the second end, the top bracket being configured to couple to a top of a door jamb; and a bottom bracket located at the bottom of the second end, the bottom bracket being configured to couple to a bottom of the door jamb.

6. The mechanism of claim 5, where the door is a double-acting door.

7. In combination, a mechanism for mounting a door, comprising: a primary spine having a first end, a second end, a top and a bottom, the primary spine being pivotally coupled at the first end to a jamb; a secondary spine having a first end, a second end, a top and a bottom, the secondary spine being pivotally coupled at the first end to the primary spine, and coupled at the second end to a door.

8. The mechanism of claim 7, where the primary spine is pivotally coupled to the jamb by two or more brackets.

9. The mechanism of claim 8, where at least one hinge protects the jamb.

10. The mechanism of claim 7, where the door is a double acting door.
